(19) United States
(12) Patent Application Publication
(10) Pub. No.: US 2002/0104263 A1
(43) Pub. Date: Aug. 8, 2002

(54) Flowerpot

(76) Inventor: Chih Pong Chang, Hsin Chu Hsien (TW)

Correspondence Address: HARRISON & EGBERT, 1018 Preston St., Suite 100, Houston, TX, 77002, US

(21) Appl. No.: 09/773,741

(22) Filed: Feb. 2, 2001

(51) Int. Cl. A01G 9/02

(52) U.S. Cl. 47/65.7

(57) ABSTRACT

A recyclable flowerpot is made of a mixture by casting. The mixture is formed of natural fibers, a reinforced resin, and a chemical substance capable of producing gas to enhance the aeration of the flowerpot so made.

### BACKGROUND OF THE INVENTION

1. Field of the Invention

The present invention relates generally to a plant-growing container, and more particularly to a flowerpot which is made of various natural fibers.

2. Description of Related Art

The conventional flowerpots are generally made of a plastic, woody, or ceramic material and are therefore poor in aeration. It is conceivable that a plant can not grow very well in a poorly-aerated flowerpot. In addition, the root system of a plant is rejected by the conventional flowerpots. The ceramic flowerpots are rather heavy and prone to crack or breakage. Moreover, the conventional flowerpots are not cost-effective.

### SUMMARY OF THE INVENTION

The primary objective of the present invention is to provide a flowerpot which is made of a mixture of natural fibers.

It is another objective of the present invention to provide a flowerpot which is made of natural fibers and organic substances capable of producing gas.

It is still another objective of the present invention to proivide a flowerpot which is made of natural fibers and inorganic substances capable of producing gas.

It is still another objective of the present invention to provide a flowerpot which is well aerated.

It is still another objective of the present invention to provide a flowerpot which has an excellent capability for holding moisture.

It is still another objective of the present invention to provide a flowerpot which is resistant to impact and breakage.

It is still another objective of the present invention to provide a recyclable flowerpot.

The present invention will be more readily understood upon a thoughtful deliberation of the following detailed description of the present invention with reference to the accompanying drawings.

### BRIEF DESCIPTION OF THE DRAWINGS

FIG. 1 shows a perspective view of a flowerpot of the present invention.

FIG. 2 shows a schematic process flow of making the flowerpot of the present invention.

FIG. 3 shows a schematic view of the making of the flowerpot of the present invention by casting.

FIGS. 4 shows another schematic view of the making of the flowerpot of the present invention by casting.

### DETAILED DESCRIPTION OF THE INVENTION

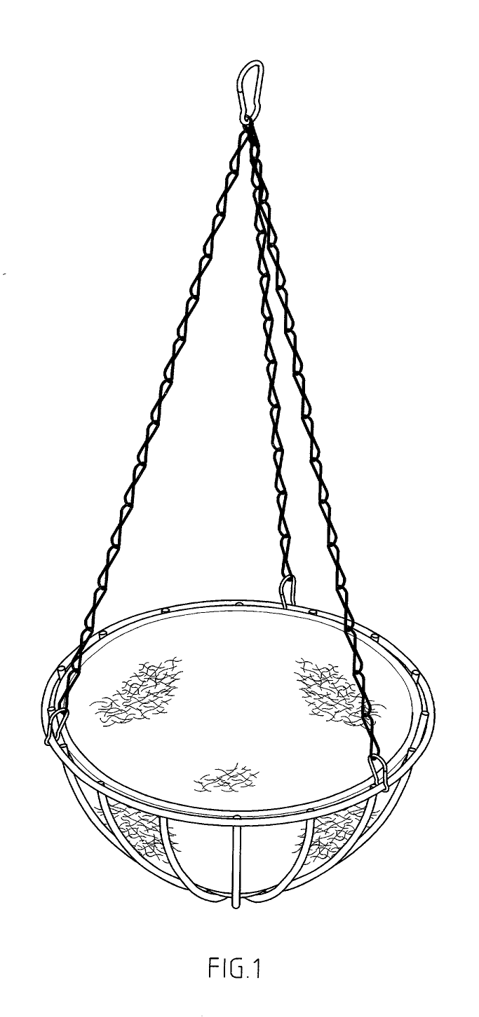

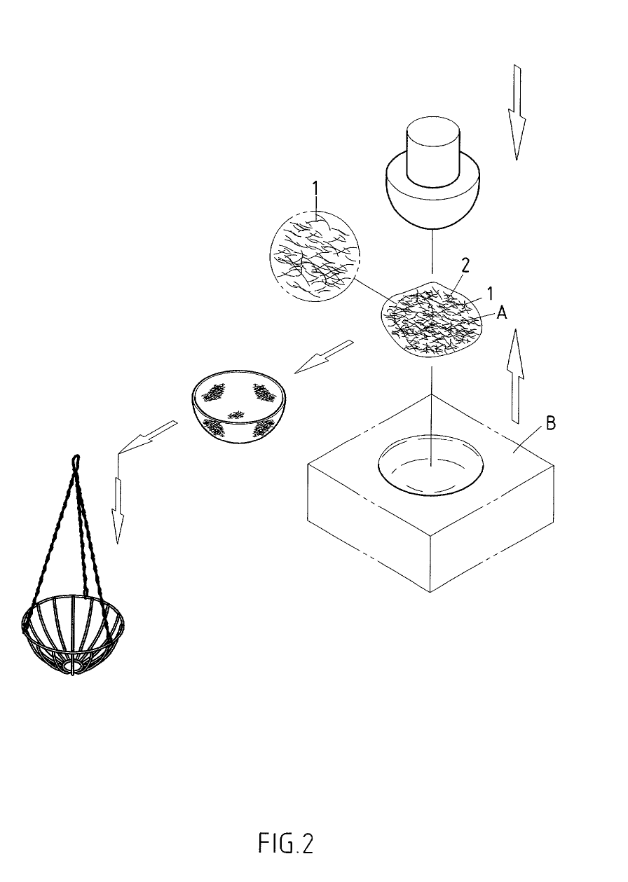

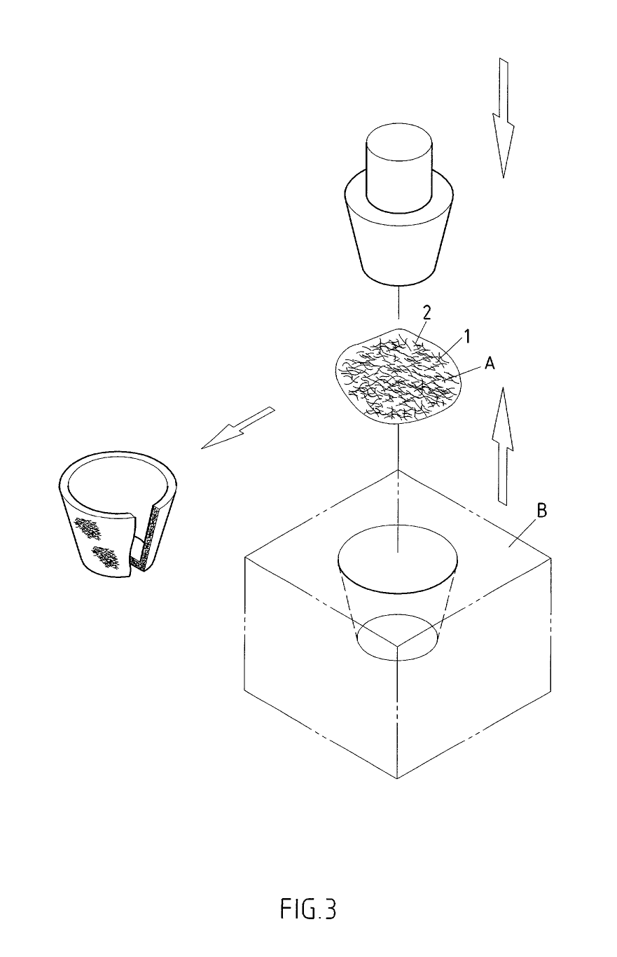

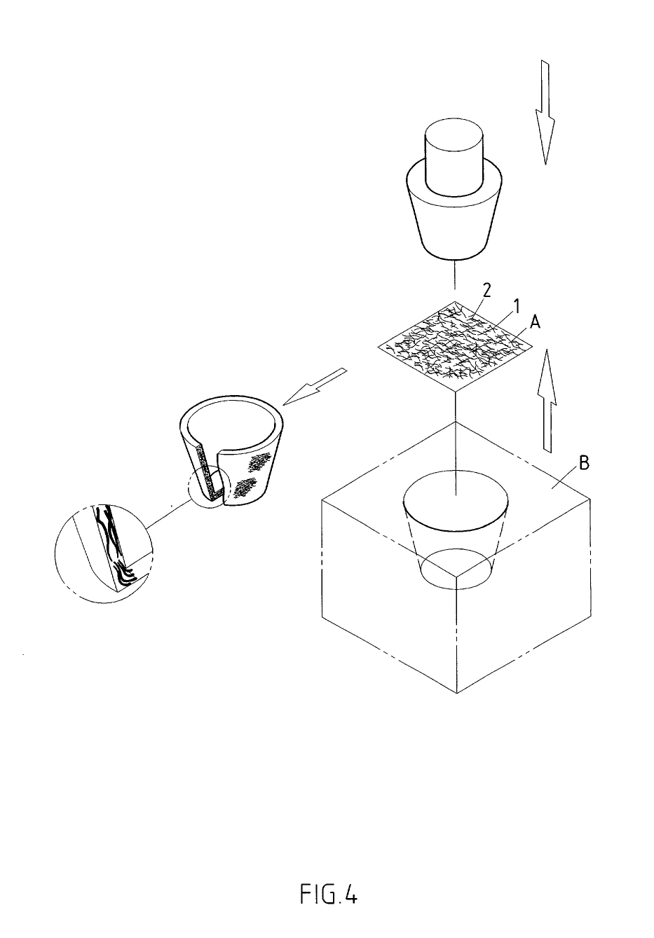

As shown in FIGS. 1-4, a flowerpot embodied in the present invention is made of a mixture “A” by casting. A mold “B” is used in forming the flowerpot of the present invention.

The mixture “A” is formed of a number of natural fibers 1 and a resin material 2. The natural fibers 1 are obtained from the woody plants, such as the palm tree, the coconut tree, as well as the fiber-rich plants, such as hemp. The resin material 2 is reinforced, and in a liquid, emulsive, or granular form.

The mixture “A” may be also formed of natural fibers 1, the resin material 2, and an organic or inorganic substance capable of producing gas.

The flowerpot of the present invention is made of the mixture “A”, which is injected into the mold “B”. The flowerpot of the present invention is formed by casting at a high temperature. The flowerpot of the present invention is well aerated, thanks to the gas bubbles produced by the organic or inorganic substance. The well-aerated flowerpot of the present invention promotes the plant growth. In addition, the natural fibers of the flowerpot of the present invention are resistant to impact and breakage. Moreover, the flowerpot of the present invention is light in weight. The flowerpot of the present invention does not reject the root system of a plant and is recyclable.

The embodiment of the present invention described above is to be regarded in all respects as being merely illustrative and not restrictive. Accordingly, the present invention may be embodied in other specific forms without deviating from the spirit thereof. The present invention is therefore to be limited only by the scopes of the following appended claims.

What is claimed is:

1. A recyclable flowerpot made of a mixture by casting whereby said mixture is formed of natural fibers and a reinforced resin.

2. The recyclable flowerpot as defined in claim 1, wherein said reinforced resin is liquid in form.

3. The recyclable flowerpot as defined in claim 1, wherein said reinforced resin is emulsive in form.

4. The recyclable flowerpot as defined in claim 1, wherein said reinforced resin is granular in form.

5. The recyclable flowerpot as defined in claim 1, wherein said mixture is formed of natural fibers, a reinforced resin, and an organic substance capable of producing gas bubbles.

6. The recyclable flowerpot as defined in claim 1, wherein said mixture is formed of natural fibers, a reinforced resin, and an inorganic substance capable of producing gas bubbles.
